(19) United States
(12) Patent Application Publication
(10) Pub. No.: US 2023/0266023 A1
(43) Pub. Date: Aug. 24, 2023

(54) INTELLIGENT AIR CONDITIONING SYSTEM

(71) Applicant: Yu-Ting TANG, Taichung City (TW)

(72) Inventor: Ping-Huey Tang, Taichung City (TW)

(73) Assignee: Yu-Ting Tang, Taichung City (TW)

(21) Appl. No.: 18/020,103

(22) PCT Filed: Dec. 11, 2020
(86) PCT No.: PCT/CN2020/135671

§ 371 Date: Feb. 7, 2023

(30) Foreign Application Priority Data
Sep. 10, 2020 (CN) 202010945090.7

(51) Int. Cl. F24F 7/08; F24F 11/89; F24F 3/16; F24F 7/003; F24F 8/10

(52) U.S. Cl. CPC F24F 7/08; F24F 11/89; F24F 3/16; F24F 7/003; F24F 8/10

(57) ABSTRACT

An intelligent air conditioning system, comprising a first air inlet channel (11), a second air inlet channel (12), an exhaust channel (13), a circulating channel (14), a main machine (15), a first switching valve (16), a second switching valve (17), a third switching valve (18), and a control unit. The circulating channel (14) is communicated with at least one space (20); the main machine (15) is provided on the circulating channel (14) to generate air flow in the circulating channel (14); the first switching valve (16) selectively enables the first air inlet channel (11) to be communicated with the circulating channel (14), the second switching valve (17) selectively enables the circulating channel (14) to be communicated with the exhaust channel (13), and the third switching valve (18) selectively enables the second air inlet channel (12) to be communicated with the circulating channel (14); the control unit is electrically connected to the first switching valve (16), the second switching valve (17), and the third switching valve (18).

### BACKGROUND OF THE INVENTION

The invention relates to the technical field of air conditioning systems, in particular to an intelligent air conditioning system.

The air conditioning system installed in the building is usually hidden in the space above the ceiling, and then connected with the indoor space through the air inlet and air outlet installed on the ceiling to achieve the purpose of ventilation and circulation.

However, the air conditioning system usually has only one air flow channel and is equipped with a filter. In this way, in a special situation, such as a fire, a large number of smoke particles generated by the fire will quickly block the filter, so that the fan operates in a no-load operation, resulting in the inability of the air flow to be discharged quickly, thus threatening the breathing and physical safety of indoor people.

In addition, the function of the existing air conditioning system is relatively single, and multiple indoor spaces in the building can only be ventilated or circulated at the same time, but cannot selectively allow some indoor spaces to be ventilated or circulated, which limits the flexibility of use, but also increases the cost of use and wastes electricity in disguise.

Therefore, the main purpose of the present invention is to provide an intelligent air conditioning system to solve the above problems.

### SUMMARY OF THE INVENTION

The purpose of the present invention is to provide an intelligent air conditioning system, which can intelligently optimize indoor air, improve air quality, create a better environment for people, and save energy.

In order to achieve at least one of the above advantages or other advantages, an embodiment of the present invention provides an intelligent air conditioning system. The intelligent air conditioning system includes a first air inlet channel, a second air inlet channel, an exhaust channel, a circulating channel, a main machine, a first switching valve, a second switching valve, a third switching valve and a control unit.

The circulating channel is communicated with at least one space. An example is the office space in a building.

The main machine is provided on the circulating channel to generate air flow in the circulating channel.

The first switching valve selectively enables the first air inlet channel to communicate with the circulating channel. For example, when the air in the indoor space requires to be renewed, the first switching valve communicates the first air inlet channel to the circulating channel to introduce external air.

The second switching valve selectively enables the circulating channel to communicate with the exhaust channel. For example, when the air in the indoor space requires to be exhausted, the second switching valve communicates the circulating channel to the exhaust channel to discharge the indoor air.

The third switching valve selectively enables the second air inlet channel to communicate with the circulating channel. For example, when an emergency is happened, the third switching valve communicates the second air inlet channel to the circulating channel to introduce outside clean air.

The control unit electrically coupled to the first switching valve, the second switching valve and the third switching valve to control the operation modes of the first switching valve, the second switching valve and the third switching valve.

In some embodiments, the main machine is provided between the first switching valve and the third switching valve, and the space is located between the third switching valve and the second switching valve.

In some embodiments, the intelligent air conditioning system may further include an air detection module provided in the space, and the control unit accords to a detection signal generated by the air detection module to control the third switching valve to enable the second air inlet channel to communicate with the circulating channel and to control the second switching valve to enable the circulating channel to communicate with the exhaust channel.

In some embodiments, the first switching valve, the second switching valve and the third switching valve are three-way switching valves.

In some embodiments, the intelligent air conditioning system may further include an auxiliary exhaust machine provided on the exhaust channel. When the main machine is blocked, damaged, etc. that affect its operation, the auxiliary exhaust machine is started to ensure the overall operation of the intelligent air conditioning system.

In some embodiments, the control unit controls the first switching valve and the second switching valve to switch synchronously.

In some embodiments, the number of the at least one space is multiple. The circulating channel includes a first diverting unit and a second diverting unit. The first diverting unit is provided downstream of the third switching valve for communicating the circulating channel to the spaces. The second diverting unit is provided upstream of the second switching valve for communicating the spaces to the circulating channel.

Further, the first diverting unit includes a first three-way pipe, and the second diverting unit includes a second three-way pipe.

Furthermore, a rotary butterfly valve is provided on each of two passages of the first three-way pipe communicated to the spaces for adjusting the air flow.

In some embodiments, the number of the at least one space is multiple. The intelligent air conditioning system further comprises a first space selection module and a second space selection module. The first space selection module is provided downstream of the third switching valve for selectively communicating the circulating channel to at least one of the spaces. The second space selection module is provided downstream of the second switching valve for selectively communicating at least one of the spaces to the circulating channel.

In some embodiments, the number of the spaces is two. The first space selection module includes a first space switching valve, and the second space selection module includes a second space switching valve.

In some embodiments, the control unit controls the first space selection module and the second space selection module to select the same space.

In some embodiments, the control unit controls the first space selection module and the second space selection module to select synchronously.

In some embodiments, the number of the multiple spaces is four. The first space selection module includes a first space switching valve, a third space switching valve and a fifth space switching valve. The first space switching valve selectively communicates the circulating channel to the third space switching valve or the fifth space switching valve. The third space switching valve and the fifth space switching valve selectively communicates the first space switching valve to at least one of the four spaces. The second space selection module includes a second space switching valve, a fourth space switching valve and a sixth space switching valve. The fourth space switching valve and the sixth space switching valve selectively communicates at least one of the four spaces to the second space switching valve. The second space switching valve selectively communicates the fourth space switching valve or the sixth space switching valve to the circulating channel.

In some embodiments, the intelligent air conditioning system may further include a plurality of air detection modules respectively provided in the spaces. The control unit accords to a plurality of detection signals generated by the plurality of air detection modules to control the first space selection module and the second space selection module to select at least one of the spaces and to control the first space switching valve and the second space switching valve to select to ventilate or circulate the selected at least one space.

In some embodiments, the intelligent air conditioning system may further include a heat exchange unit provided upstream of the main machine.

In some embodiments, the intelligent air conditioning system may further include an air purification unit provided between the heat exchange unit and the main machine.

Therefore, the intelligent air conditioning system provided by the present invention uses the control unit to control the plurality of switching valves, which can intelligently improve indoor air quality, create a better environment for people, and save energy. In addition, the control unit can accord to the detection signal generated by the air detection module to more accurately control the immediate operating state of each switching valve.

The above description is only an overview of the technical solution of the present invention. In order to more clearly understand the technical solution of the present invention, to implement the technical solution according to the contents of the specification, and in order to make the above and other objects, features and advantages of the present invention more apparent, preferred embodiments are described hereinafter in detail with reference to the drawings.

### BRIEF DESCRIPTION OF DRAWINGS

The accompanying drawings, which are included to provide a further understanding of the embodiments of the present application, constitute a part of the specification, are used to illustrate the embodiments of the present application, and together with the description, serve to explain the principles of the present application. Obviously, the accompanying drawings in the following description are only some examples of the present application, and are not intended to limit the embodiments of the present invention. Other drawings may also be derived from these accompanying drawings for the skilled person in the art. The accompanying drawings include:

FIG. 1 is a schematic structural diagram of an intelligent air conditioning system in a circulation mode according to a first embodiment of the present invention;

FIG. 2 is a schematic structural diagram of the intelligent air conditioning system in a renewed ventilation mode according to the first embodiment of the present invention;

FIG. 3 is a schematic structural diagram of the intelligent air conditioning system in an emergency mode according to the first embodiment of the present invention;

FIG. 4 is a schematic structural diagram of an intelligent air conditioning system according to a second embodiment of the present invention;

FIG. 4A is a schematic structural diagram of a rotary butterfly valve installed in the intelligent air conditioning system according to the second embodiment of the present invention;

FIG. 5 is a schematic structural diagram of an intelligent air conditioning system according to a third embodiment of the present invention;

FIG. 6 is a schematic structural diagram of an intelligent air conditioning system according to a fourth embodiment of the present invention; and

FIG. 7 is a schematic structural diagram of an intelligent air conditioning system according to a fifth embodiment of the present invention.

### DETAILED DESCRIPTION OF THE INVENTION

Specific structural and functional details disclosed herein are merely representative and for purposes of describing exemplary embodiments of the present invention. However, the present invention may be embodied in many alternative forms and should not be construed as limited only to the embodiments set forth herein.

In the description of the present invention, it should be understood that the orientation or positional relationship indicated by the terms “center”, “lateral”, “top”, “bottom”, “left”, “right”, “vertical”, “horizontal”, “top”, “bottom”, “inside”, “outside”, etc. is based on the orientation or positional relationship shown in the accompanying drawings, and is only for the convenience of describing the present invention and simplifying the description, rather than indicating or implying the indicated device or the components must have a particular orientation, or be constructed and operated in a particular orientation, and therefore should not be construed as limiting the invention. In addition, the terms “first” and “second” are only used for descriptive purposes, and should not be construed as indicating or implying relative importance or implying the number of indicated technical features. Thus, a feature defined as “first” or “second” may expressly or implicitly include one or more of that feature. In the description of the present invention, unless otherwise specified, “plurality” means two or more. In addition, the term “comprising” and any variations thereof mean “at least including”.

In the description of the present invention, it should be noted that the terms “installed”, “coupled” and “connected” should be understood in a broad sense, unless otherwise expressly specified and limited, for example, it may be a fixed connection, a detachable connection, or an integral connection; it can be a mechanical connection or an electrical connection; it can be a direct connection or an indirect connection through an intermediate medium, and it can be the internal connection of the two components. For the skilled person in the art, the specific meanings of the above terms in the present invention can be understood in specific situations.

The terminology used herein is for the purpose of describing specific embodiments only and is not intended to limit the exemplary embodiments. As used herein, the singular forms “a”, “an”, and “the” are intended to include the multiple forms as well, unless the context clearly indicates otherwise. It should also be understood that the terms “comprising” and/or “including” as used herein specify the presence of stated features, integers, steps, operations, units and/or components, but do not preclude the presence or addition of one or more other features, integers, steps, operations, units, components and/or combinations thereof.

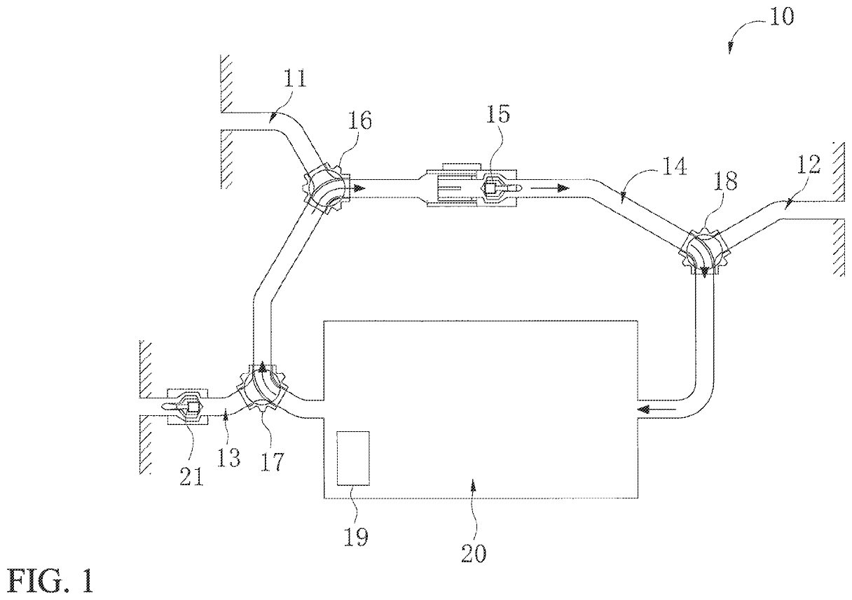

FIG. 1 is a schematic structural diagram of an intelligent air conditioning system 10 in a circulation mode according to a first embodiment of the present invention. In order to achieve at least one of the aforementioned advantages or other advantages, the first embodiment of the present invention provides an intelligent air conditioning system 10.

As shown in FIG. 1, the intelligent air conditioning system 10 includes a first air inlet channel 11, a second air inlet channel 12, an exhaust channel 13, a circulating channel 14, a main machine 15, a first switching valve 16, a second switching valve 17, a third switching valve 18, a control unit (not shown) and an air detection module 19.

The circulating channel 14 communicates with a space 20, such as an indoor space of a building, which is located between the third switching valve 18 and the second switching valve 17. The main machine 15 is provided on the circulating channel 14 and between the first switching valve 16 and the third switching valve 18 to generate air flow in the circulating channel 14. In other words, when the main machine 15 operates, an air flow will be generated in the circulating channel 14. In an embodiment, the main machine 15 may be a high volume, high efficiency fan driven by a brushless DC variable frequency motor. Further, in an embodiment, the main machine 15 may be installed a filter with HEPA H13 level to remove PM2.5 and purify the air flow.

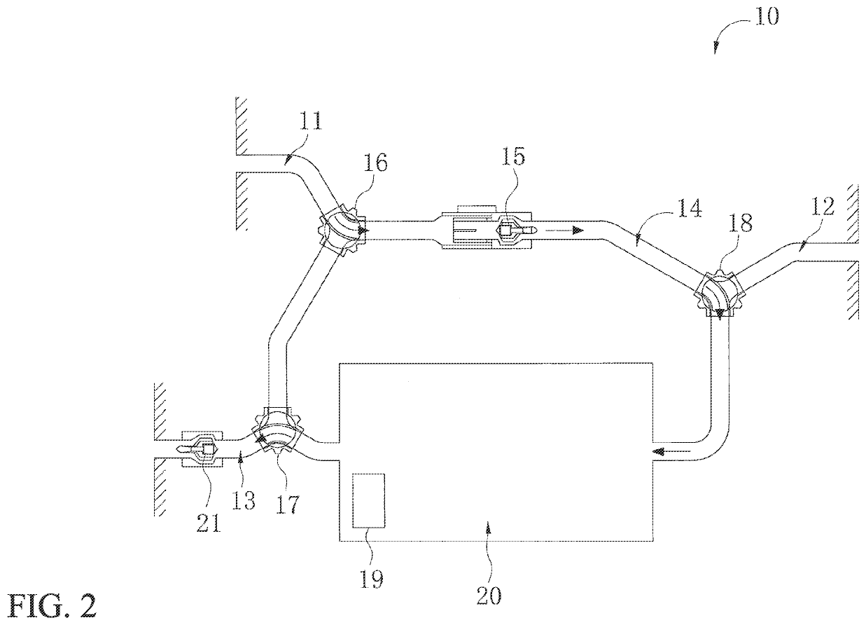

The air detection module 19 is provided in the space 20 for detecting the air quality in the space 20, and according to the detected air quality, a detection signal is generated and transmitted to the control unit. In an embodiment, the air detection module 19 includes an air quality detector to detect air temperature and humidity, and the concentration of CO, CO2, TVOC (Total Volatile Organic Compounds), ozone, formaldehyde and other harmful pollutants in the air, and the PM2.5 concentration, and to generate and transmit the detection signal according to the detected results to the control unit. The control unit can switch the intelligent air conditioning system 10 to a corresponding operation mode according to the detection signal. For example, when it is detected that the air temperature and humidity are low, the cooling air discharge of the intelligent air conditioning system 10 is reduced to ensure the comfort of people in the space 20. When it is detected that the PM2.5 concentration is too high, increase the rotation speed of the main machine 15 to increase the ventilation speed. When it is detected that the concentrations of CO, CO2, and TVOC in the air fit the preset safety standards, the operation mode of the intelligent air conditioning system 10 is switched to the circulation mode. When it is detected that the concentration of CO, CO2, and TVOC in the air exceeds the preset safety standard, the operation mode of the intelligent air conditioning system 10 is switched to a renewed mode, which will be more detailed in the paragraph corresponding to FIG. 2. When it is detected that an emergency occurs in the space 20 (such as a fire, or a sealed package of the harmful volatile liquid accidentally broken), the operation mode of the intelligent air conditioning system 10 is adjusted to an emergency mode, which will be more detailed in the paragraph corresponding to FIG. 2.

The control unit is electrically coupled to the first switching valve 16, the second switching valve 17 and the third switching valve 18 to control the operating states of the first switching valve 16, the second switching valve 17 and third switching valve 18 according to the detection signal generated by the air detection module 19. In an embodiment, the control unit may be electrically coupled to and controls the operating states of the first switching valve 16, the second switching valve 17 and the third switching valve 18 through wires. However, it is not limited to this. In another embodiment, the control unit can also be electrically coupled wirelessly to and control the operating states of the first switching valve 16, the second switching valve 17 and the third switching valve 18.

In this embodiment, the operation mode of the intelligent air conditioning system 10 is the circulation mode. The first switching valve 16 disconnects the connection between the first air inlet channel 11 and the circulating channel 14, the second switching valve 17 disconnects the connection between the exhaust channel 13 and the circulating channel 14, and the third switching valve 18 disconnects the connection between the second air inlet channel 12 and the circulating channel 14, prevents external air from flowing into the circulating channel 14. For example, the air circulating in the space 20 and the circulating channel 14 is cold air. When the operation mode of the intelligent air conditioning system 10 is switched to the circulation mode, the entry of external hot air can be avoided, the circulation of cold air can be ensured, and electricity can be saved.

FIG. 2 is a schematic structural diagram of the intelligent air conditioning system in a renewed ventilation mode according to the first embodiment of the present invention. When people feel uncomfortable breathing, they can manually switch the intelligent air conditioning system 10 to the renewed ventilation mode; or when the air detection module 19 detects that the concentrations of CO, CO2 and TVOC in the air are relatively high, and determines that the air in the space 20 is required to renew, the intelligent air conditioning system 10 also can be switched to the renewed ventilation mode. In addition, in another embodiment, the intelligent air conditioning system 10 can also be switched to the renewed ventilation mode according to a preset time schedule to renew the air in the space 20.

As shown in FIG. 2, when the intelligent air conditioning system 10 is in the renewed ventilation mode, the control unit controls the first switching valve 16 to communicate with the first air inlet channel 11 and the circulating channel 14, and the second switching valve 17 to communicate with the exhaust channel 13 and the circulating channel 14. The third switching valve 18 still disconnects the connection between the second air inlet channel 12 and the circulating channel 14. At this time, an air flow is generated that enters from the first air inlet channel 11, flows through the space 20, and then discharges from the exhaust channel 13. Thus, the air in the space 20 is renewed, and the air quality is improved.

In an embodiment, please refer to FIG. 1 and FIG. 2 together, in the switching process of the intelligent air conditioning system 10 of the present invention between the circulation mode and the renewed ventilation mode, the control unit controls the first switching valve 16 and the second switching valve 17 synchronously.

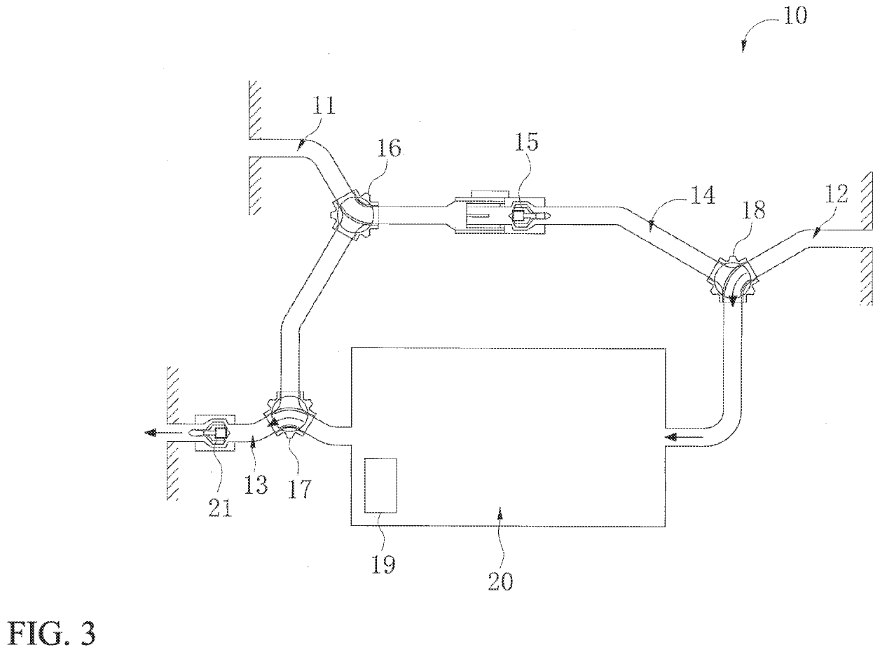

FIG. 3 is a schematic structural diagram of the intelligent air conditioning system 10 in an emergency mode according to the first embodiment of the present invention. When an emergency situation occurs in the space 20, such as a fire, or a sealed package of the harmful volatile liquid is accidentally broken, the intelligent air conditioning system 10 can automatically switch to the emergency mode. In one embodiment, the air detection module 19 may notify the control unit to switch the intelligent air conditioning system 10 to the emergency mode by detecting that the concentration of CO and CO2 in the air exceeds a predetermined value, or when a large number of smoke particles are detected. However, it is not limited to this. In another embodiment, it is also possible to determine whether the intelligent air conditioning system 10 needs to be switched to the emergency mode by detecting the choking state of the filter of the main machine 15.

When the outbreak of a fire, the main machine 15 of the intelligent air conditioning system 10 in the circulation mode would be quickly blocked by a large number of smoke particles generated by the fire, that is, the main machine 15 could not operate normally. At this time, by switching the intelligent air conditioning system 10 to the emergency mode, the dense smoke in the space 20 can be quickly exhausted to the outside.

As shown in FIG. 3, the intelligent air conditioning system 10 further includes an auxiliary exhaust machine 21 provided on the exhaust channel 13 for generating an air flow in the circulating channel 14. When the intelligent air conditioning system 10 is in the emergency mode, the control unit controls the second switching valve 17 to communicate the exhaust channel 13 with the circulating channel 14, and the control unit controls the third switching valve 18 to communicate with the second air inlet channel 12 and the circulating channel 14. At this time, an air flow is generated that enters from the second air inlet channel 12, flows through the space 20, and is discharged from the exhaust channel 13. Thereby, t

Thus, when the main machine 15 cannot operate normally, the dense smoke in the space 20 can be quickly exhausted to the outside through the auxiliary exhaust machine 21 to ensure the safety of people.

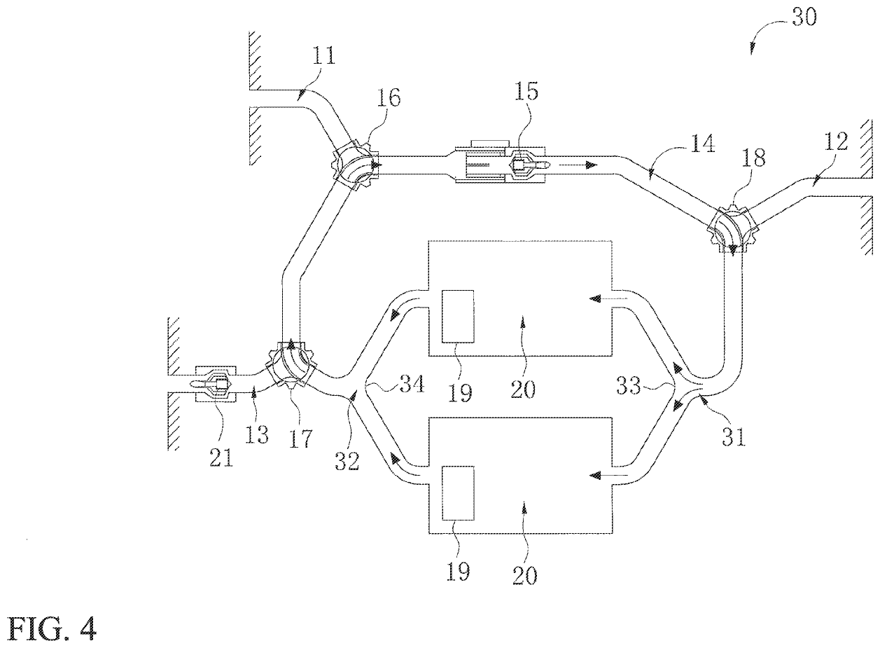

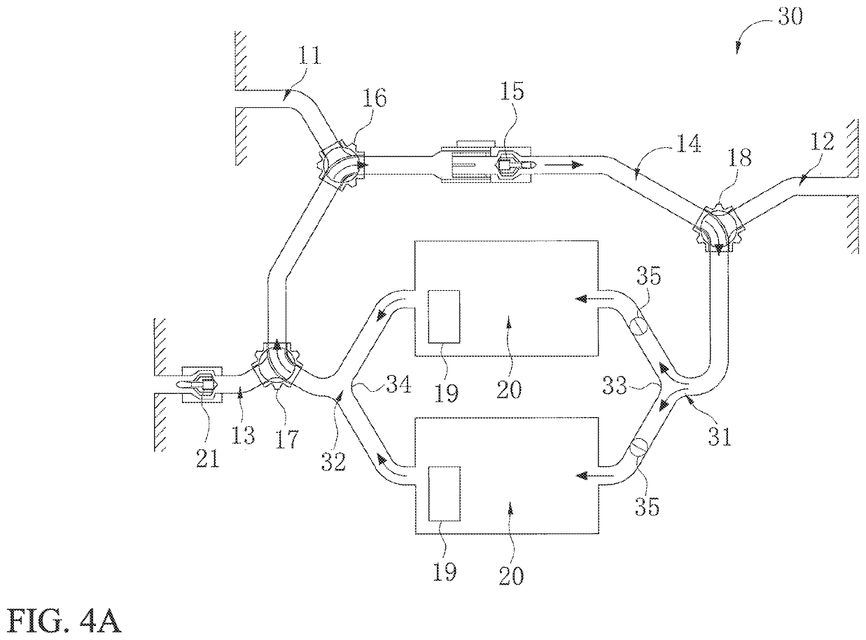

Please refer to FIG. 4 in conjunction with FIG. 1. FIG. 4 is a schematic structural diagram of an intelligent air conditioning system 30 according to a second embodiment of the present invention. In order to achieve at least one of the aforementioned advantages or other advantages, the second embodiment of the present invention further provides an intelligent air conditioning system 30.

As compared with the intelligent air conditioning system 10 of the first embodiment, the circulating channel 14 of the intelligent air conditioning system 30 of the second embodiment further includes a first diverting unit 31 and a second diverting unit 32, and the circulating channel 14 is communicated with two spaces 20. Each space 20 is provided with an independent air detection module 19.

The first diverting unit 31 is provided downstream of the third switching valve 18 for communicating the circulating channel 14 to the two spaces 20. The second diverting unit 32 is provided upstream of the second switching valve 17 for communicating the two spaces 20 to the circulating channel 14. The upstream and downstream are defined from the flow direction of the respective switching valve facing the air flow. Taking the third switching valve 18 in FIG. 4 as an example, the flow direction of the air flow is from the upper left to the lower, and the upper left is the upstream of the third switching valve 18, and the lower is the downstream of the third switching valve 18.

In this embodiment, the first diverting unit 31 communicates the circulating channel 14 to the two spaces 20 through a first three-way pipe 33. The second diverting unit 32 communicates the circulating channel 14 to the two spaces 20 through a second three-way pipe 34. The intelligent air conditioning system 30 of the second embodiment can improve the air quality of the two spaces 20 simultaneously to fit the needs of the actual space area.

In addition, if the intelligent air conditioning system 30 of the second embodiment is to be switched to renewed ventilation mode, it could refer to the first switching valve 16, the second switching valve 17 and the third switching valve 18 accordingly switched in the intelligent air conditioning system 10 in FIG. 2. If the intelligent air conditioning system 30 of the second embodiment is to be switched to the emergency mode, it could refer to the first switching valve 16, the second switching valve 17 and the third switching valve 18 accordingly switched in the intelligent air conditioning system 10 in FIG. 3.

Further, in one embodiment, as shown in FIG. 4A, a rotary butterfly valve 35 is provided on each of two passages of the first three-way pipe 33 communicated to the two spaces 20. For example, when there is no people in the lower space 20, the rotary butterfly valve 35 on the passage of the first three-way pipe 33 communicated to the lower space 20 is switched to a closed state, so that the air flow cannot pass there, thereby increasing the flow rate through the upper space 20. The rotary butterfly valve 35 may be wirelessly controlled by the control unit.

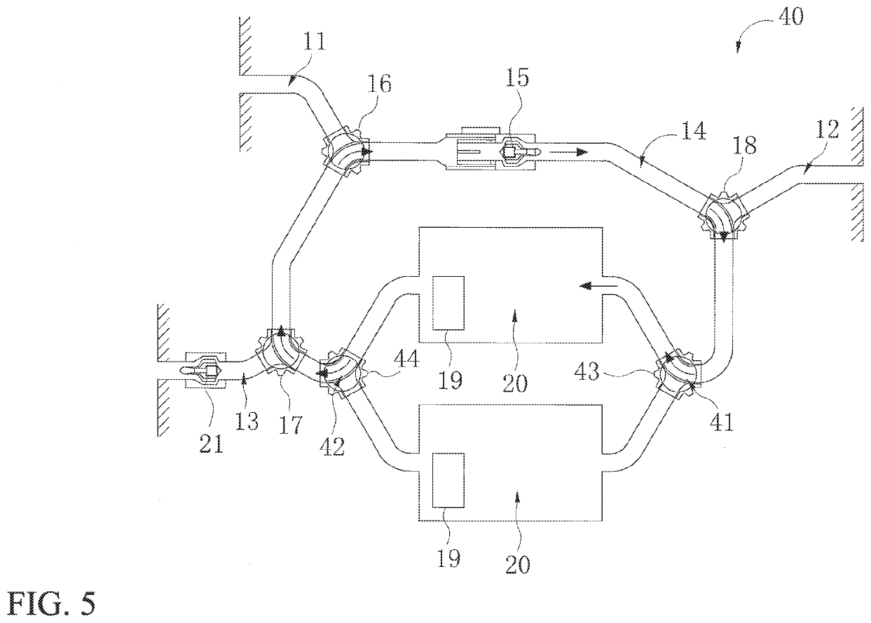

FIG. 5 is a schematic structural diagram of an intelligent air conditioning system 40 according to a third embodiment of the present invention. In order to achieve at least one of the aforementioned advantages or other advantages, the third embodiment of the present invention further provides an intelligent air conditioning system 40.

As compared with the intelligent air conditioning system 10 of the first embodiment, the intelligent air conditioning system 40 of the third embodiment further includes a first space selection module 41 and a second space selection module 42, and the circulating channel 14 is communicated with two spaces 20. Each space 20 is provided with an independent air detection module 19.

The first space selection module 41 is provided downstream of the third switching valve 18 for selectively communicating the circulating channel 14 to at least one of the two spaces 20. The second space selection module 42 is provided downstream of the second switching valve 17 for selectively communicating at least one of the two spaces 20 to the circulating channel 14. The upstream and downstream are defined from the flow direction of the respective switching valve facing the air flow. Taking the third switching valve 18 in FIG. 5 as an example, the flow direction of the air flow is from the upper left to the lower, and the upper left is the upstream of the third switching valve 18, and the lower is the downstream of the third switching valve 18.

In this embodiment, the first space selection module 41 communicates the circulating channel 14 to at least one of the two spaces 20 through a first space switching valve 43. The second space selection module 42 communicates the circulating channel 14 to at least one of the two spaces 20 through a second space switching valve 44. The first space switching valve 43 and the second space switching valve 44 can selectively communicate the circulating channel 14 to one of the two spaces 20, so as to perform operations such as circulation and ventilation for the selected space 20. By switching the operating states of the first space switching valve 43 and the second space switching valve 44, the space 20 that most requires to be ventilated can be ventilated, which helps to save power and improve the efficiency of the intelligent air conditioning system 40. Further, the first space switching valve 43 and the second space switching valve 44 are both electrically coupled to the aforementioned control unit, and the control unit accords the detection signal generated by the air detection module 19 in each space 20 to switch the operating states of the first space switching valve 43 and the second space switching valve 44.

For example, when one of the two spaces 20 is unoccupied and the other space 20 is occupied, the control unit controls the first space switching valve 43 and the second space switching valve 44 to communicate the occupied space 20 to the circulating channel 14, the connection between the other unoccupied space 20 and the circulating channel 14 is disconnected. At this time, the air flow only circulates in the unoccupied space 20. As compared with the intelligent air conditioning system 30 of FIG. 4, the intelligent air conditioning system 40 to achieve the same ventilation (or circulation) efficiency in the space 20, only half the air flow rate is required, which helps to save energy.

In one embodiment, the control unit controls the first space selection module 41 and the second space selection module 42 to select the same space 20. The control unit controls the first space selection module 41 and the second space selection module 42 to select synchronously.

In addition, if the intelligent air conditioning system 40 of the third embodiment is to be switched to the renewed ventilation mode, it could refer to the first switching valve 16, the second switching valve 17 and the third switching valve 18 accordingly switched in the intelligent air conditioning system 10 in FIG. 2. If the intelligent air conditioning system 40 of the third embodiment is to be switched to the emergency mode, it could refer to the first switching valve 16, the second switching valve 17 and the third switching valve 18 accordingly switched in the intelligent air conditioning system 10 in FIG. 3.

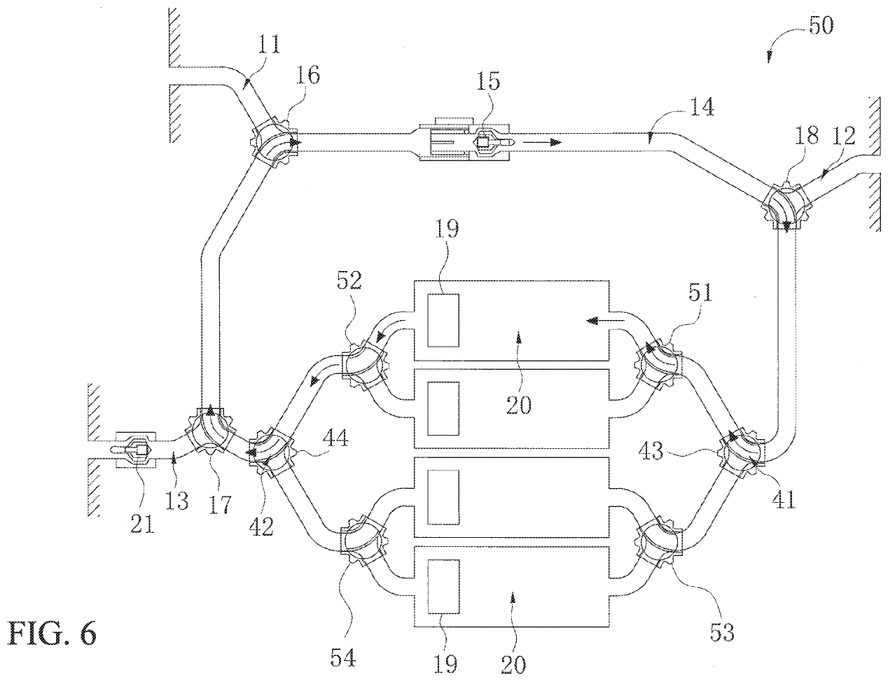

FIG. 6 is a schematic structural diagram of an intelligent air conditioning system 50 according to a fourth embodiment of the present invention. In order to achieve at least one of the aforementioned advantages or other advantages, the fourth embodiment of the present invention further provides an intelligent air conditioning system 50.

As compared with the intelligent air conditioning system 10 of the first embodiment, the intelligent air conditioning system 50 of the fourth embodiment further includes a first space selection module 41 and a second space selection module 42, and the circulating channel 14 is communicated with four spaces 20. Each space 20 is provided with an independent air detection module 19.

The first space selection module 41 is provided downstream of the third switching valve 18 for selectively communicating the circulating channel 14 to at least one of the four spaces 20. The second space selection module 42 is provided downstream of the second switching valve 17 for selectively communicating at least one of the four spaces 20 to the circulating channel 14. The upstream and downstream are defined from the flow direction of the respective switching valve facing the air flow. Taking the third switching valve 18 in FIG. 6 as an example, the flow direction of the air flow is from the upper left to the lower, and the upper left is the upstream of the third switching valve 18, and the lower is the downstream of the third switching valve 18.

Further, the first space selection module 41 includes a first space switching valve 43, a third space switching valve 51 and a fifth space switching valve 53. The first space switching valve 43 selectively communicates the circulating channel 14 to the third space switching valve 51 or the fifth space switching valve 53, and the third space switching valve 51 and the fifth space switching valve 53 selectively communicates the first space switching valve 43 to at least one of the four spaces 20. The second space selection module 42 includes a second space switching valve 44, a fourth space switching valve 52 and a sixth space switching valve 54. The fourth space switching valve 52 and the sixth space switching valve 54 selectively communicates at least one of the four spaces (20) to the second space switching valve 44. The second space switching valve 44 selectively communicates the fourth space switching valve 52 or the sixth space switching valve 54 to the circulating channel 14. Further, the first space switching valve 43, the second space switching valve 44, the third space switching valve 51, the fourth space switching valve 52, the fifth space switching valve 53 and the sixth space switching valve 54 are all electrically coupled to the aforementioned control unit, and the control unit accords the detection signal generated by the air detection module 19 in each space 20 to switch the operating states of the relative space switching valve.

For example, as FIG. 6 shows, when only the uppermost space 20 is occupied, the circulating channel 14 is communicated with the uppermost space 20, and the first space switching valve 43 communicates the circulating channel 14 to the third space switching valve 51, the third space switching valve 51 communicates the uppermost space 20 to the first space switching valve 43, the fourth space switching valve 52 communicates the uppermost space 20 to the second space switching valve 44, and the second space switching valve 44 communicates the fourth space switching valve 52 to the circulating channel 14, to constitute a complete air flow path. At this time, the air flow only circulates in the uppermost space 20 where there are people. As compared with the embodiment in which the three-way pipe is used to communicate the spaces, to achieve the same ventilation (or circulation) efficiency in the space 20, only a quarter of the air flow rate is required, which helps to save energy.

In addition, if the intelligent air conditioning system 50 of the fourth embodiment is to be switched to the renewed ventilation mode, it could refer to the first switching valve 16, the second switching valve 17 and the third switching valve 18 accordingly switched in the intelligent air conditioning system 10 in FIG. 2. If the intelligent air conditioning system 50 of the fourth embodiment is to be switched to the emergency mode, it could refer to the first switching valve 16, the second switching valve 17 and the third switching valve 18 accordingly switched in the intelligent air conditioning system 10 in FIG. 3.

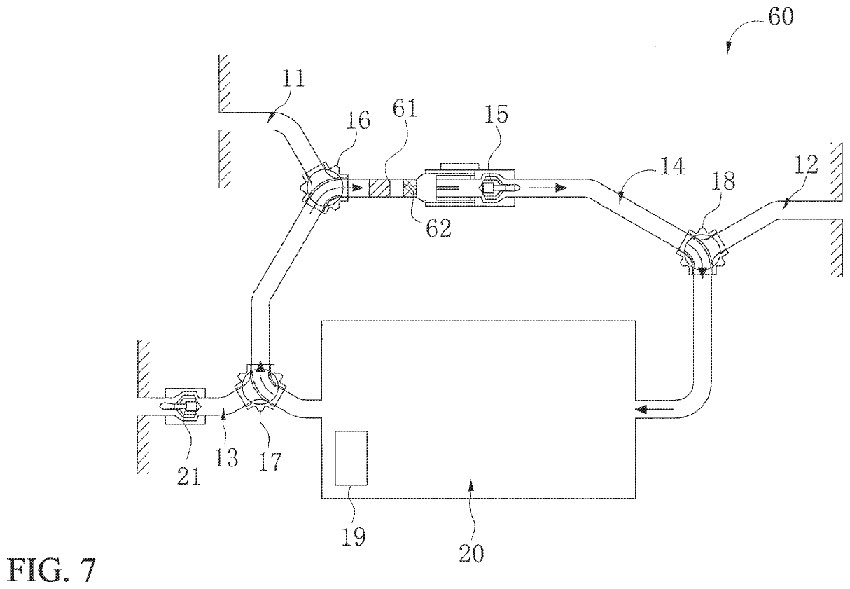

FIG. 7 is a schematic structural diagram of an intelligent air conditioning system according to a fifth embodiment of the present invention. In order to achieve at least one of the aforementioned advantages or other advantages, the fifth embodiment of the present invention further provides an intelligent air conditioning system 60.

As compared with the intelligent air conditioning system 10 of the first embodiment, the intelligent air conditioning system 60 of the fifth embodiment further includes a heat exchange unit 61 and an air purification unit 62.

The heat exchange unit 61 is provided on the circulating channel 14 and is located between the main machine 15 and the first switching valve 16, that is, at the upstream of the main machine 15. The heat exchange unit 61 may adjust the temperature of the air flow emitted to the space 20 by the main machine 15 as required. For example, when the intelligent air conditioning system 60 is operated, the renewed air (refers to the air that has not been circulated by the intelligent air conditioning system 60 before entering the space 20) can be pre-cooled and dried in summer, and the renewed air can be pre-heated and humidified in winter to adjust the temperature in the space 20.

The air purification unit 62 is provided between the heat exchange unit 61 and the main machine 15 for purifying the air passing through the heat exchange unit 61. Since the heat exchange unit 61 is used for a long time, it easily becomes a bacteria breeding ground. The air passing through the heat exchange unit 61 will carry these bacteria. The air purification unit 62 arranged behind the heat exchange unit 61 in this embodiment can filter out the bacteria in the air, clean the air, and create a better environment for the people in the space 20.

In addition, in one embodiment, the heat exchange unit 61 may also be provided on the first air inlet channel 11.

In any of the above embodiments, the first switching valve 16, the second switching valve 17 and the third switching valve 18 are all three-way switching valves. However, the present invention is not limited to this embodiment, the first switching valve 16, the second switching valve 17 and the third switching valve 18 may be replaced depending on the number of connected channels, such as a four-way switching valve, a five-way switching valve, and the like.

The above manual adjustment of the operation mode of the intelligent air conditioning system 10 may be realized by software such as a mobile phone app, a tablet app, and a PC software. The air detection module 19 transmits the detection signal to the control unit by Wi-Fi, Bluetooth, the internet, etc. The intelligent air conditioning system 10 of the present invention may also be used in the indoor space of the house.

As supplementary, when the number of spaces 20 is three, the air inlet channel of two spaces 20 can be communicated to the same space switching valve, for example, the space switching valve is a three-way switching valve, and then the space switching valve and the other space 20 are communicated to another space switching valve, and the arrangement of the exhaust channels of the spaces can same as that of the space switching valves. The control unit controls the operating state of each space switching valve, so that each space 20 can be ventilated and circulated and the like. When the number of spaces 20 is multiple and odd, any three adjacent spaces 20 are communicated with a four-way switching valve, and every two of the remaining even spaces 20 as a group are communicated with a three-way switching valve to control the operating state of each switching valve through the control unit for switching the operation modes such as ventilation and circulation in each space 20.

According to the foregoing description, the intelligent air conditioning system 10 provided by the present invention uses the control unit to control the plurality of switching valves, which can intelligently improve indoor air quality, create a better environment for people, and save energy. In addition, the control unit can accord to the detection signal generated by the air detection module to more accurately control the immediate operating state of each switching valve.

The above are only preferred embodiments of the present invention and are not intended to limit the present invention, and for those skilled in the art, the present invention may have various modifications and variations. Any modifications, equivalent substitutions, improvements and the like made within the spirit and principle of the present invention fall within the scope of the present invention.

1. An intelligent air conditioning system comprising:
a first air inlet channel;
a second air inlet channel;
an exhaust channel;
a circulating channel communicated with at least one space;
a main machine provided on the circulating channel to generate air flow in the circulating channel;
a first switching valve selectively enabling the first air inlet channel to communicate with the circulating channel;
a second switching valve selectively enabling the circulating channel to communicate with the exhaust channel;
a third switching valve selectively enabling the second air inlet channel to communicate with the circulating channel; and
a control unit electrically coupled to the first switching valve, the second switching valve and the third switching valve.

2. The intelligent air conditioning system as claimed in claim 1, wherein the main machine is provided between the first switching valve and the third switching valve, and wherein the at least one space is located between the third switching valve and the second switching valve.

3. The intelligent air conditioning system as claimed in claim 1, further comprising an air detection module provided in the at least one space, and wherein the control unit accords to a detection signal generated by the air detection module to control the first switching valve, the second switching valve and the third switching valve.

4. The intelligent air conditioning system as claimed in claim 1, wherein the first switching valve, the second switching valve and the third switching valve are three-way switching valves.

5. The intelligent air conditioning system as claimed in claim 1, further comprising an auxiliary exhaust machine provided on the exhaust channel.

6. The intelligent air conditioning system as claimed in claim 1, wherein the control unit controls the first switching valve and the second switching valve to switch synchronously.

7. The intelligent air conditioning system as claimed in claim 1, wherein the number of the at least one space is multiple, wherein the circulating channel comprises:
a first diverting unit provided downstream of the third switching valve for communicating the circulating channel to the spaces; and
a second diverting unit provided upstream of the second switching valve for communicating the spaces to the circulating channel.

8. The intelligent air conditioning system as claimed in claim 7, wherein the first diverting unit includes a first three-way pipe, and wherein the second diverting unit includes a second three-way pipe.

9. The intelligent air conditioning system as claimed in claim 8, wherein a rotary butterfly valve is provided on each of two passages of the first three-way pipe communicated to the spaces.

10. The intelligent air conditioning system as claimed in claim 1, wherein the number of the at least one space is multiple, wherein the intelligent air conditioning system further comprises:
a first space selection module provided downstream of the third switching valve for selectively communicating the circulating channel to at least one of the spaces; and
a second space selection module provided downstream of the second switching valve for selectively communicating at least one of the spaces to the circulating channel.

11. The intelligent air conditioning system of claim 10, wherein the number of the spaces is two, wherein the first space selection module includes a first space switching valve, and wherein the second space selection module includes a second space switching valve.

12. The intelligent air conditioning system of claim 10, wherein the control unit controls the first space selection module and the second space selection module to select the same space.

13. The intelligent air conditioning system as claimed in claim 10, wherein the control unit controls the first space selection module and the second space selection module to select synchronously.

14. The intelligent air conditioning system of claim 10, wherein the number of the multiple spaces is four, wherein the first space selection module includes a first space switching valve, a third space switching valve and a fifth space switching valve, wherein the first space switching valve selectively communicates the circulating channel to the third space switching valve or the fifth space switching valve, wherein the third space switching valve and the fifth space switching valve selectively communicates the first space switching valve to at least one of the four spaces, wherein the second space selection module includes a second space switching valve, a fourth space switching valve and a sixth space switching valve, wherein the fourth space switching valve and the sixth space switching valve selectively communicates at least one of the four spaces to the second space switching valve, and wherein the second space switching valve selectively communicates the fourth space switching valve or the sixth space switching valve to the circulating channel.

15. The intelligent air conditioning system as claimed in claim 10, further comprising a plurality of air detection modules respectively provided in the spaces, wherein the control unit accords to a plurality of detection signals generated by the plurality of air detection modules to control the first space selection module and the second space selection module to select at least one of the spaces and to control the first space switching valve and the second space switching valve to select to ventilate or circulate the selected at least one space.

16. The intelligent air conditioning system as claimed in claim 1, further comprising a heat exchange unit provided upstream of the main machine.

17. The intelligent air conditioning system as claimed in claim 16, further comprising an air purification unit provided between the heat exchange unit and the main machine.
